(19) United States
(12) Patent Application Publication
(10) Pub. No.: US 2012/0300710 A1
(43) Pub. Date: Nov. 29, 2012

(54) Distributing L2 Baseband Processing in a Radio Network

(75) Inventors: Zheng Li, San Jose, CA (US); Jan Erik Johan Berglund, Hangzhou (CN); Jussi Matti Sipola, Helsinki (FI); Manuel Enrique Ramirez Montalvo, Espoo (FI)

(73) Assignee: Nokia Siemens Networks Oy

(21) Appl. No.: 13/117,375

(22) Filed: May 27, 2011

(51) Int. Cl. H04W 72/04

(52) U.S. Cl. 370/329

(57) ABSTRACT

Functions for a data link layer are split between an access point and an access controller. The functions performed for uplink and downlink for the data link layer are some but not all of the functions performed by the data link layer to convert information between transport channels and radio bearers.

### TECHNICAL FIELD

This invention relates generally to radio frequency communications and, more specifically, relates to mobile communication stacks.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

ACK/NACK acknowledgement/negative acknowledgement

AFE analog front end

ARQ automatic repeat request

AM acknowledged mode

BB base band

BTS base transceiver station

CoMP coordinated multipoint

CPRI common public radio interface

C-RAN cloud RAN

DFE digital front end

DL downlink (from base station to user equipment)

DPD digital pre-distortion

eNB EUTRAN Node B (evolved Node B/base station)

EPC evolved packet core

EUTRAN evolved universal terrestrial access network

FDD frequency division duplexing

HARQ hybrid automatic repeat request

HSDPA high speed downlink packet access

HW hardware

IPsec internet protocol security

IT information technology

L1 layer 1 (physical layer)

L2 layer 2 (data link layer)

L3 layer 3 (network layer)

LTE long term evolution

MAC medium access control

NAS non-access stratum

OBSAI open base station architecture initiative

PDCCH physical downlink control channel

PDCP packet data convergence protocol

PDU protocol data unit

PDSCH physical downlink shared channel

PoC proof of concept

PUCCH packet uplink control channel

PUSCH packet uplink shared channel

RAN radio access network

RF radio frequency

RLC radio link control

ROHC robust header compression

RRC radio resource control

SAP service access point

SCH synchronization channel

SDU service data unit

SON self organized network

SRIO serial rapid input output

SW software

UL uplink (from user equipment to base station)

UM unacknowledged mode

UMTS universal mobile telecommunication system

WLAN wireless local area network

One modern communication system is known as evolved UTRAN (E-UTRAN, also referred to as UTRAN-LTE or as E-UTRA). FIG. 1 reproduces FIG. 4-1 of 3GPP TS 36.300 (V10.3.0 (2011-03), Rel-10) and shows an overall architecture of the EUTRAN system. The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to an S-GW by means of a S1 interface (MME/S-GW). The S1 interface supports a many-to-many relationship between MMEs/S-GWs/UPEs and eNBs. In this system, the DL access technique is OFDMA, and the UL access technique is SC-FDMA. The EUTRAN system shown in FIG. 1 is one possible system in which the exemplary embodiments of the instant invention might be used.

Of particular interest herein are the further releases of 3GPP LTE (e.g., LTE Rel-10, LTE Rel-11) targeted towards future IMT-A systems, referred to herein for convenience simply as LTE-Advanced (LTE-A). LTE-A is specified in Rel-10 (see, e.g., 3GPP TS 36.300 v10.3.0 (2011-03)), further enhancements in Rel-11. Reference in this regard may also be made to 3GPP TR 36.913 V9.0.0 (2009-12) Technical Report 3rd Generation Partnership Project; Technical Specification Group Radio Access Network; Requirements for further advancements for Evolved Universal Terrestrial Radio Access (E-UTRA) (LTE-Advanced) (Release 9). Reference can also be made to 3GPP TR 36.912 V9.3.0 (2010-06) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

Coordinated multi-point (CoMP) transmission and reception is considered for LTE-A as a tool to improve the coverage of high data rates. In this type of system, multiple geographically separated points and antenna(s) at these points receive signals from or transmit signals to multiple user equipments.

### SUMMARY

The following summary is merely intended to be exemplary. The summary is not intended to limit the scope of the claims.

In an aspect of the invention, an apparatus is disclosed that includes an interface coupled to an access controller, one or more processors, and one or more memories including computer program code. The one or more memories and the computer program code are configured to, with the one or more processors, cause the apparatus to perform at least the following: converting, in downlink, radio frequency signals received from one or more user equipments into corresponding information on transport channels and converting, in uplink, information on the transport channels into the radio frequency signals suitable to be transmitted to one or more user equipments. The converting includes performing at least operations for a physical layer. The one or more memories and the computer program code are configured to, with the one or more processors, cause the apparatus to perform at least the following: performing functions, in uplink, for a data link layer on the information on the transport channels to determine packet signals and sending the packet signals over the interface to the access controller, and performing functions, in downlink, for the data link layer on packet signals received over the interface to create the information on the transport channels. The functions in downlink include downlink packet scheduling functions and downlink medium access control functions and the functions in uplink include uplink packet scheduling functions. The functions performed for uplink and downlink are some but not all of the functions performed by the data link layer to convert information between transport channels and radio bearers.

In another exemplary embodiment, a method includes converting, in downlink, radio frequency signals received from one or more user equipments into corresponding information on transport channels and converting, in uplink, information on the transport channels into the radio frequency signals suitable to be transmitted to one or more user equipments. The converting includes performing at least operations for a physical layer. The method also includes performing functions, in uplink, for a data link layer on the information on the transport channels to determine packet signals and sending the packet signals over the interface to the access controller, and performing functions, in downlink, for the data link layer on packet signals received over the interface to create the information on the transport channels. The functions in downlink include downlink packet scheduling functions and downlink medium access control functions and the functions in uplink include uplink packet scheduling functions. The functions performed for uplink and downlink are some but not all of the functions performed by the data link layer to convert information between transport channels and radio bearers.

In another aspect, another apparatus is disclosed that includes an interface coupled to an access point, one or more processors, and one or more memories including computer program code. The one or more memories and the computer program code are configured to, with the one or more processors, cause the apparatus to perform at least the following: in downlink, receiving information on radio bearers, performing functions for a data link layer on the information on the radio bearers to determine packet signals, sending the packet signals over the interface to the access point, and performing control plane functions. The functions in downlink for the data link layer include performing packet data control protocol functions. The one or more memories and the computer program code are configured to, with the one or more processors, cause the apparatus to perform at least the following: in uplink, receiving packet signals over the interface, performing functions for the data link layer on the received packet signals to create information on the radio bearers, and performing control plane functions. The functions in uplink for the data link layer include performing packet data control protocol functions, wherein the functions performed for uplink and downlink for the data link layer are some but not all of the functions performed by the data link layer to convert information between transport channels and radio bearers.

In another exemplary embodiment, a method includes, in downlink, receiving information on radio bearers, performing functions for a data link layer on the information on the radio bearers to determine packet signals, sending the packet signals over the interface to the access point, and performing control plane functions. The functions in downlink for the data link layer include performing packet data control protocol functions. The method further includes, in uplink, receiving packet signals over the interface, performing functions for the data link layer on the received packet signals to create information on the radio bearers, and performing control plane functions. The functions in uplink for the data link layer include performing packet data control protocol functions, wherein the functions performed for uplink and downlink for the data link layer are some but not all of the functions performed by the data link layer to convert information between transport channels and radio bearers.

### BRIEF DESCRIPTION OF THE DRAWINGS

In the attached Drawing Figures:

FIG. 1 reproduces FIG. 4-1 of 3GPP TS 36.300 (V10.3.0 (2011-03)) and shows the overall architecture of the EUTRAN system (Rel-10).

FIG. 2 is a block diagram of a macro LTE eNB architecture.

FIG. 3 is a block diagram of a femto LTE eNB architecture.

FIG. 4 reproduces FIG. 6-1, layer 2 structure for DL, of 3GPP TS 36.300 (V10.3.0 (2011-03)).

FIG. 5 reproduces FIG. 6-2, layer 2 structure for UL, of 3GPP TS 36.300 (V10.3.0 (2011-03)).

FIG. 6 is a high level block diagram of layers 1 and 2, illustrating functional elements a real-time DL HARQ loop through the functional elements.

FIG. 7 is a high level block diagram of layers 1 and 2, illustrating functional elements a real-time UL HARQ loop through the functional elements.

FIG. 8 is a high level block diagram of layers 1 and 2, illustrating functional elements a real-time DL/UL scheduler interaction loop through the functional elements.

FIG. 9 shows a simplified block diagram of various electronic devices that are suitable for use in practicing the exemplary embodiments of this invention.

FIG. 10 shows an exemplary block diagram of an access point—access controller architecture in accordance with an exemplary embodiment of the instant invention.

FIG. 11 is a high level block diagram of layers 1 and 2, illustrating functional elements and exemplary splits between the functional elements for four exemplary deployment scenarios.

FIG. 12 shows a modified version of FIG. 4.3.2-1, the control-plane protocol stack, from 3GPP TS 36.300 (V10.3.0 (2011-03)).

FIG. 13 is a logic flow diagram performed by an access point that illustrates the operation of a method, and a result of execution of computer program instructions embodied on a computer readable medium, in accordance with the exemplary embodiments of this invention.

FIG. 14 is a logic flow diagram performed by an access controller that illustrates the operation of a method, and a result of execution of computer program instructions embodied on a computer readable medium, in accordance with the exemplary embodiments of this invention.

### DETAILED DESCRIPTION OF THE DRAWINGS

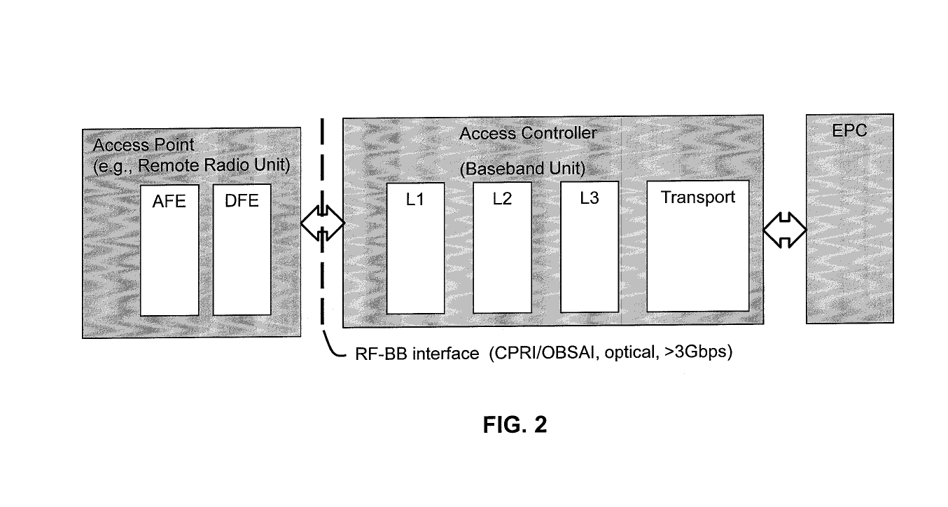

As described above, CoMP reception is considered for LTE-A as a tool to improve the coverage of high data rates and to increase system throughput. In the macro LTE radio network of today, access points (e.g., remote radio head) and access controllers (e.g., baseband units) are connected via standard interfaces such as CPRI or OBSAI. The entire baseband processing is carried out in the access controllers while there is no baseband processing at all in the access points. FIG. 2 is an example of this, where the access point contains analog front end (AFE) circuitry and digital front end (DFE) circuitry in the access point (e.g., RRH) and the access controller comprises a baseband unit comprising the circuitry for the layers L1 (also called the physical layer), L2 (also called the data link layer) and L3 (also called the network layer) and transport circuitry. The access controller communicates with the evolved packet core (EPC).

For such architecture, a high speed optical fiber interface (greater than three Gbps, gigabits per second) is required between the access point and access controller. This is not an issue if the access point is installed on top of a mast while access controller is at the foot of mast. However, this becomes a large problem in a cloud-RAN (C-RAN) architecture, where the access point and access controller can be separated by hundreds of meters or even many kilometers.

The C-RAN architecture is mostly impractical for outdoor deployment due to lack of accessible optical backhaul in most countries. Even in an indoor enterprise deployment, most in-building wiring infrastructure can only support up to about 1 (one) Gbps throughput with CAT 5e (category 5, enhanced) cabling.

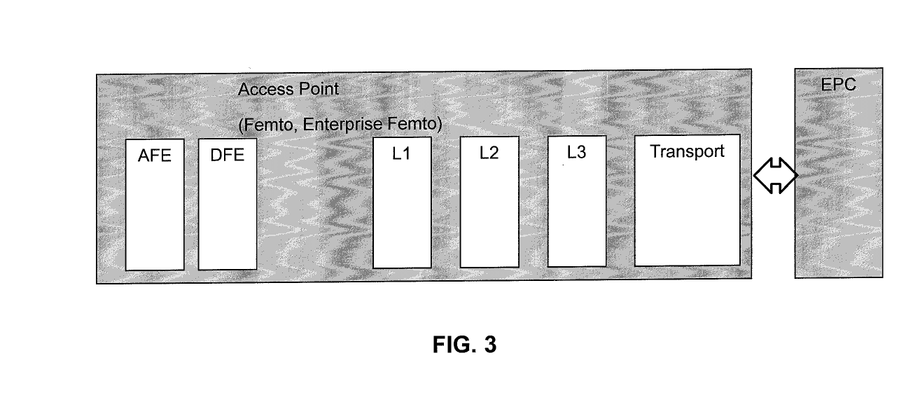

At the other extreme end of spectrum, femto or enterprise femto devices are used, where there is no access controller at all since all functionalities including baseband processing are performed in the access point. See FIG. 3.

Common problems with such highly integrated systems (e.g., home eNB, enterprise femto) include the following: a lack of feature parity with macro eNB; a lack of performance; these are difficult to upgrade to support more advanced features in LTE-Advanced.

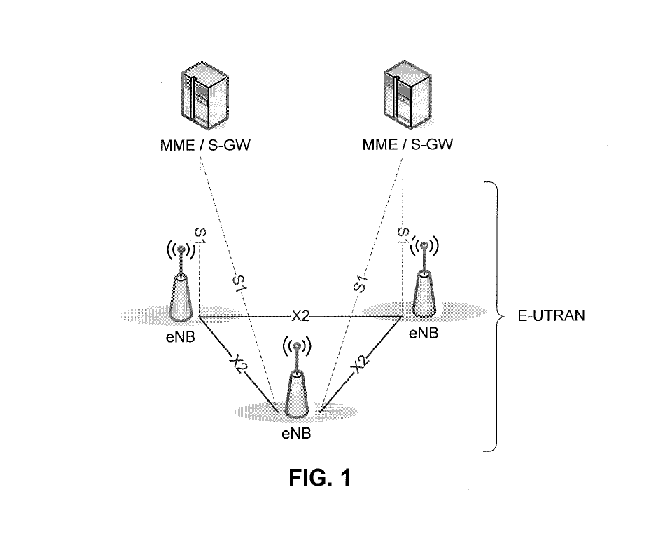

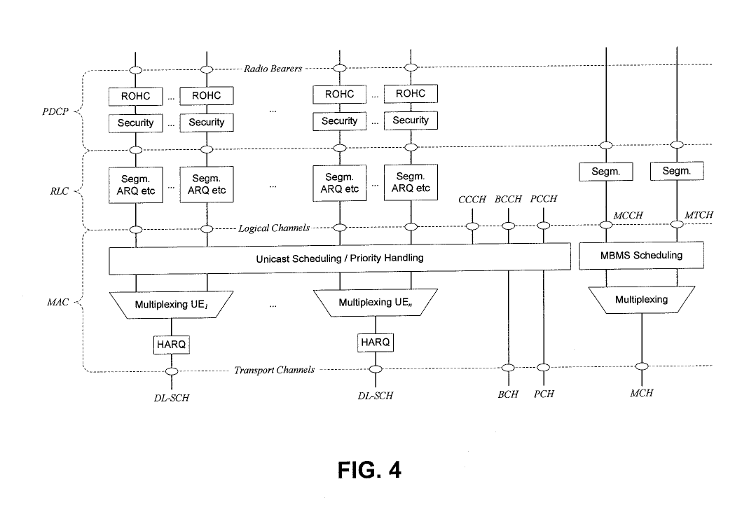

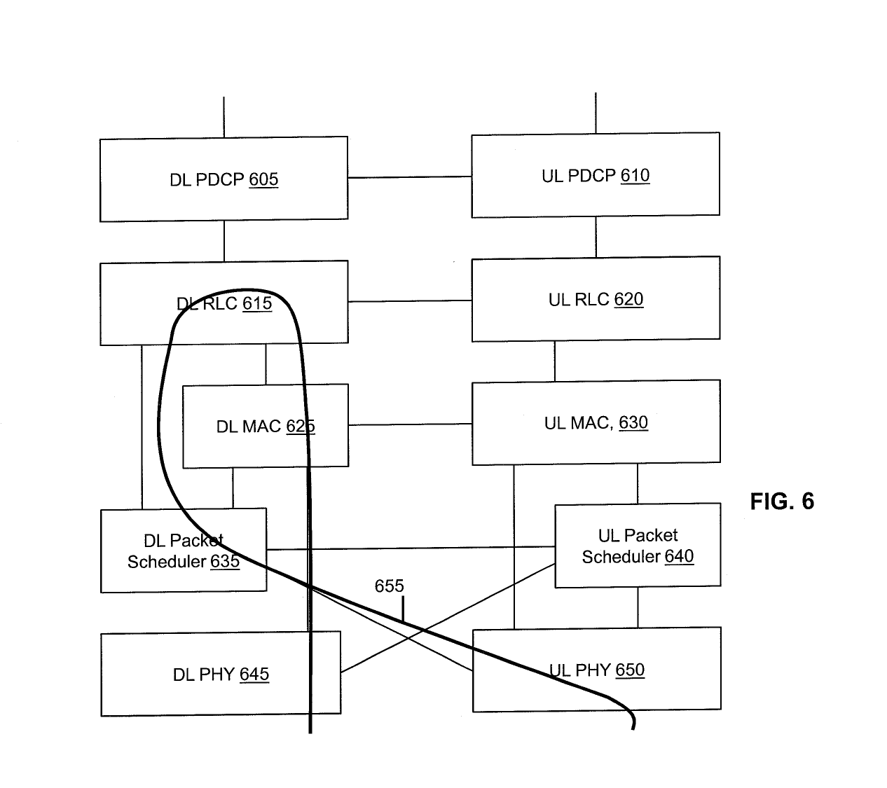

Alternatively, some baseband processing could be left in the access points. One problem to solve is to select which functionalities to place in which node (access point or access controller). This is particularly true with respect to the L2 layer (i.e., data link layer), as this layer (as described below) has strict latency requirements. FIG. 4 reproduces FIG. 6-1, layer 2 structure for DL, of 3GPP TS 36.300 (V10.3.0 (2011-03)). This figure shows the MAC sub-layer, RLC sub-layer, and the PDCP sub-layer for the data link layer/L2 layer for DL. The functions performed by the sub-layer in FIG. 4 are performed by circuitry and are typically performed by a base station such as an eNB. Service Access Points (SAPs) for peer-to-peer communication are marked with circles at the interface between sub-layers. The SAPs between the physical layer and the MAC sub-layer provides the transport channels. The SAPs between the MAC sub-layer and the RLC sub-layer provide the logical channels. The multiplexing of several logical channels (i.e., radio bearers) on the same transport channel (i.e., transport block) is performed by the MAC sub-layer. See section 6 of 3GPP TS 36.300.

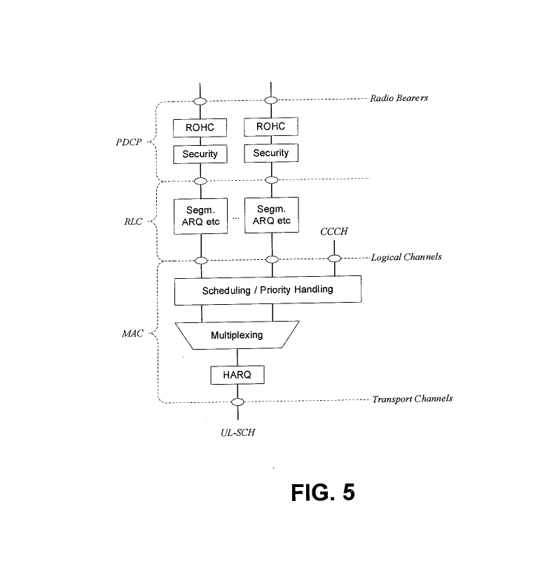

FIG. 5 reproduces FIG. 6-2, layer 2 structure for UL, of 3GPP TS 36.300 (V10.3.0 (2011-03)). FIG. 5 shows the MAC sub-layer, RLC sub-layer, and the PDCP sub-layer for the data link layer/L2 layer for UL. The functions performed by the sub-layer in FIG. 5 are performed by circuitry and are performed by a user equipment. However, the eNB would have similar sub-layers, as shown in FIGS. 6-8 and 11.

As stated above, one problem to solve is to select which functionalities to place in which node (access point or access controller). The functionality left in the access controller should be maximized to enable efficient pooling of resources. On the other hand, L2 processing and packet scheduling is latency-critical due to strict HARQ loop timing requirements connected to the physical layer air interface. This would mean that remote deployment of the L2 layer causes strict latency requirements on the interface between the access points and access controllers, leading to an expensive interface. For example, when the access points are located far away from the access controllers, copper is out of consideration and there is a need for optical fiber or microwaves with SRIO interfaces. So the target is to deploy all latency-critical functionality in the access point.

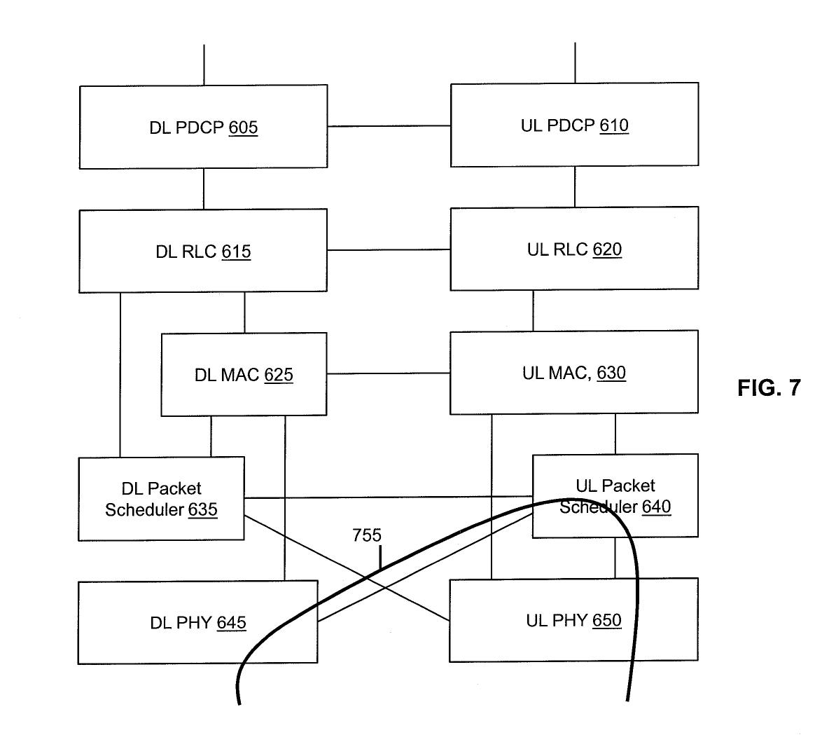

In particular, the latency requirements for the eNB functionality in the downlink HARQ loop are critical. See FIG. 6, which shows a high level block diagram of layers 1 and 2, illustrating functional elements a real-time DL HARQ loop 655 through the functional elements. The downlink L2 layer includes the DL PDCP functionality 605 (corresponding to the PDCP sub-layer shown in FIG. 4), the DL RLC functionality 615 (corresponding to the RLC sub-layer shown in FIG. 4), the DL MAC functionality 625 (corresponding to most of the MAC sub-layer shown in FIG. 4, other than the unicast scheduling/priority handling functionality), and the DL packet scheduler 635 (corresponding to the unicast scheduling/priority handling functionality shown in FIG. 4. The uplink L2 layer includes the UL PDCP functionality 610, the UL RLC functionality 620, the UL MAC functionality 630, and the UL packet scheduler 650. It is noted each of these functions corresponds to the functions in FIG. 5, but each operation operates in the reverse. That is, the MAC sub-layer in FIG. 5 multiplexes MAC SDUs (service data units), while the UL MAC functionality 630 would demultiplex MAC SDUs. The UL RLC 620 would perform, e.g., desegmentation and ARQ. The UL PDCP would perform, e.g., security removal and header decompression. Also shown are the DL PHY (L1) functionality/layer 645 and the UL PHY (L1) functionality/layer 650. The lines between the elements in FIG. 7 indicate connections between the elements. The latency critical functionalities are considered to be the following: The DL RLC functionality 615, the DL MAC functionality 625, the DL and UL packet schedulers 625, 635, and the DL and UL PHY functionality/layers 645, 650. These functionalities are also considering latency critical in FIGS. 7, 8, and 11.

The DL HARQ loop 655 shows an example of a HARQ loop, which should meet a latency requirement of 3 ms (milliseconds). The latency requirements for DL HARQ include the following:
L1 reception (by UL PHY functionality 650) of downlink HARQ ACK/NACK information on PUCCH or PUSCH;
Downlink packet scheduler 635 functionality;
Downlink RLC and MAC protocol data unit (PDU) building (by DL RLC functionality 615 and DL MAC functionality 625);
L1 transmission of control information on PDCCH (by DL PHY functionality/layer 645); and
L1 Transmission of downlink MAC PDU on PDSCH (by DL PHY functionality/layer 645).

Latency requirements for uplink HARQ loop 755 (see FIG. 7) functionality of the include the following:
L1 reception of uplink MAC PDU on PUSCH (by UL PHY functionality/layer 650);
Uplink packet scheduler 640 functionality;
L1 transmission of control information on PDCCH (by DL PHY functionality/layer 645).
   Note that the uplink HARQ loop 755 does not require MAC and RLC protocol handling.

In a typical implementation, the budget for the eNB functionality in both HARQ loops 655, 755 is three ms (milliseconds).

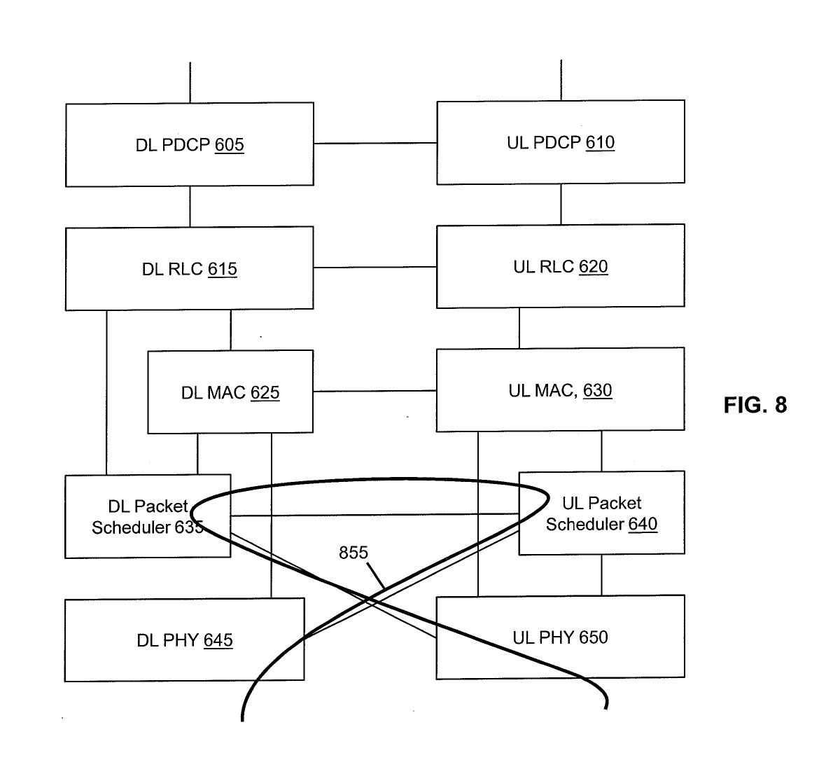

FIG. 8 is a high level block diagram of layers 1 and 2, illustrating functional elements a real-time DL/UL scheduler interaction loop 855 through the functional elements. This loop 855 also has latency requirements. In particular, the uplink and downlink packet schedulers need to communicate in this loop to agree how the resources of the PDCCH channel are shared between downlink and uplink signaling.

UMTS architecture places RLC and MAC protocols in the RNC and L1 in the Node B. This does not support HARQ. In the HSDPA architecture of UMTS, the HARQ part of MAC is placed in the Node B. In an enterprise WLAN architecture, a similar access point and controller structure has been used from certain vendors. Although the products from the above vendors all use proprietary protocols, an IEEE CAPWAP protocol has been proposed to standardize the split-MAC interface in WLAN. However, each of these architectures still leaves time-critical functions in their respective control elements and still requires high data rates between the control elements and the points providing wireless interactions with client devices.

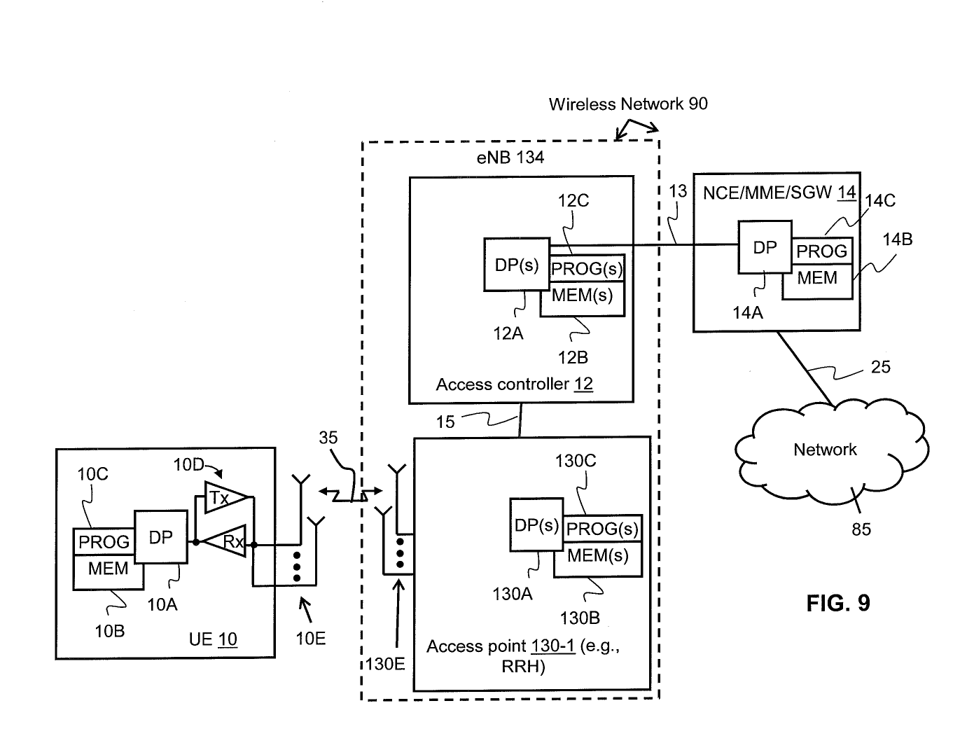

Before describing the exemplary embodiments of this invention, reference is made to FIG. 9 for illustrating a simplified block diagram of various apparatus that are suitable for use in practicing the exemplary embodiments of this invention. In FIG. 9, a wireless network 90 includes an access controller 12, an NCE/MME/SGW 14, and an access point 130, shown as a RRH 130. The wireless network 90 is adapted for communication over wireless link 35 with an apparatus 10, such as mobile communication devices which may be referred to as a UE 10, via a network access node, such as an eNB (base station), and more specifically an access controller 12 and the access point 130. In an exemplary embodiment of FIG. 9, the access point 130 and the access controller 12 form an eNB 134. It should be noted that there may be multiple access points 130 for one access controller 12. The network 90 may include a network control element (NCE) 14 that may include MME/SGW functionality and provide access to the EPC, and which provides connectivity with a further network, such as a telephone network and/or a data communications network 85 (e.g., the internet) through link 25. The NCE 14 includes a controller, such as at least one data processor (DP) 14A, and at least one computer-readable memory medium embodied as a memory (MEM) 14B that stores a program of computer instructions (PROG) 10C.

The UE 10 includes a controller, such as at least one data processor (DP) 10A, at least one computer-readable memory medium embodied as a memory (MEM) 10B that stores a program of computer instructions (PROG) 10C, and at least one suitable radio frequency (RF) transceiver 10D for bidirectional wireless communications with the access point 130 (and the access controller 12) via one or more antennas 10E.

The access controller 12 also includes a controller, such as at least data processor (DP) 12A, at least one computer-readable memory medium embodied as a memory (MEM) 12B that stores a program of computer instructions (PROG) 12C. Additional detail regarding other circuitry in the access controller 12 is described below. The access controller 12 is coupled via a data and control path 13 to the NCE 14. The path 13 may be implemented as an Si interface, as shown in FIG. 1. The access controller 12 may also be coupled to access point 130 via link 15, described in more detail below.

In this example, the access point 130 includes a controller, such as at least one data processor (DP) 130A, at least one computer-readable memory medium embodied as a memory (MEM) 130B that stores a program of computer instructions (PROG) 130C, and one or more antennas 130E (as stated above, typically several when MIMO operation is in use). The access point 130 communicates with the UE 10 via a link 35. Additional detail about the access point 130 is provided below.

At least one of the PROGs 12C and 130C is assumed to include program instructions that, when executed by the associated DP(s), enable the corresponding apparatus to operate in accordance with the exemplary embodiments of this invention, as will be discussed below in greater detail. That is, the exemplary embodiments of this invention may be implemented at least in part by computer software when executed by the DP(s) 12A of the access controller 12, and/or by the DP(s) 130A of the access controller, or by hardware (e.g., an integrated circuit configured to perform one or more of the operations described herein), or by a combination of software and hardware.

The computer-readable memories 12B and 130B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 12A and 130A may be of any type suitable to the local technical environment, and may include one or more of general purpose computers, special purpose computers, microprocessors, digital signal processors (DSPs) and processors based on multi-core processor architectures, as non-limiting examples.

Now that exemplary apparatus have been described, additional detail about the exemplary embodiments is provided. This invention proposes techniques to re-partition the functionality split between the access point and access controller, which in turn result in a new interface between the two entities.

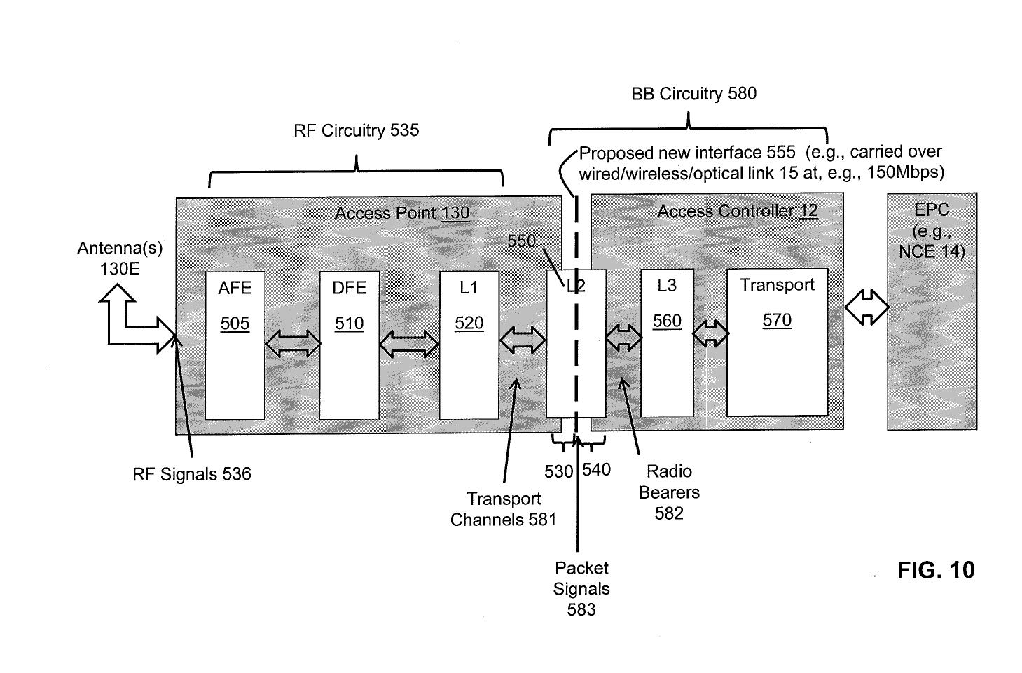

Turning to FIG. 10, this figure shows an exemplary block diagram of an access point—access controller architecture in accordance with an exemplary embodiment of the instant invention. In this exemplary embodiment, the access point 130 incorporates L1 functionality 520 and the time critical part of L2 functionality. The access point 130 includes the AFE circuitry 505, which is coupled to the antenna(s) 130E, and which receives RF signals 536 from and transmits RF signals 536 to one or multiple user equipments. The access point 130 also includes the DFE circuitry 510. The RF circuitry 535 includes the AFE 505, the DFE circuitry 510, and the L1 functionality 520. The L1 functionality 520 operates on information on transport channels 581 (see also FIGS. 4 and 5). The time critical part of L2 functionality is placed in the L2 functionality portion 530, and the remaining part of the L2 functionality is placed in the L2 functionality portion 540. The BB circuitry 580 includes the L2 functionality 550 (both portions 530 and 540), the L3 functionality 560, and the transport functionality 570. The L3 functionality 560 includes, e.g., IP (internet protocol), UDP (user datagram protocol), and the GTP (GPRS tunneling protocol, where GPRS stands for general radio packet service). L3 functionality 560 performs RRC signaling towards the UE and SIAP signaling towards the EPC. Transport functionality 570 handles the physical and logical links for S1 and X2 interfaces. Transport implements low layer protocols (typically IP, IPsec, Ethernet) of the interface towards the EPC. The access controller 12 includes the L2 functionality portion 540, the L3 functionality 560, and the transport functionality 570. The L2 functionality portion 540 interfaces with the L3 functionality 560 via radio bearers 582. The access point 130 and the access controller 12 communicate via the interface 555, which operates using packet signals 583. The interface 555 is carried over link 15 shown in FIG. 9. The interface 555 may be, e.g., a physical interface such as an Ethernet interface and the physical interface will be coupled to the copper/wireless/optical link 15. That is, the interface 555 may be a wired interface coupled to a copper link 15, a wireless interface providing a wireless link 15, or an optical interface coupled to an optical link 15. The interface 555 may also include a software interface to enable communication via, e.g., Ethernet protocol or other protocols and may include messaging types compatible with Ethernet protocol or other protocols.

In addition, part of the baseband functionality can be optimized when co-located and merged with the DFE circuitry 510 of the access point 130. One example is the digital pre-distortion.

The access controller incorporates L3 functionality 560 and non time critical part 540 of the L2 functionality 550. Organized in a pool (i.e., of multiple access controllers 12), access controllers 12 are the processing core in C-RAN architecture. Efficient load balancing, fault tolerance and easy upgrade to support LTE-Advanced features can be realized centrally in the access controller pool. In addition, coordinated radio resource management and system wide interference avoidance can be implemented in the access controller 12 which has visibility to many access points 130.

An example of a proposed new interface will typically require (as an example) 150 Mbps (megabits per second) throughput for a 20 MHz 2×2 MIMO FDD-LTE system, which is a magnitude lower than the 3 Gbps required in existing systems. Copper or even wireless backhaul links 15 (see FIG. 10) can be utilized between the access point 130 and access controller 120 to carry information over the interface 555. Also, even though optical interfaces need not be used, the backhaul link 15 may also be an optical link such as optical fiber.

The exact line where the access point 130 and access controller 12 split depends on design tradeoffs such as latency, implementation complexity, security, and standard protocol availability.

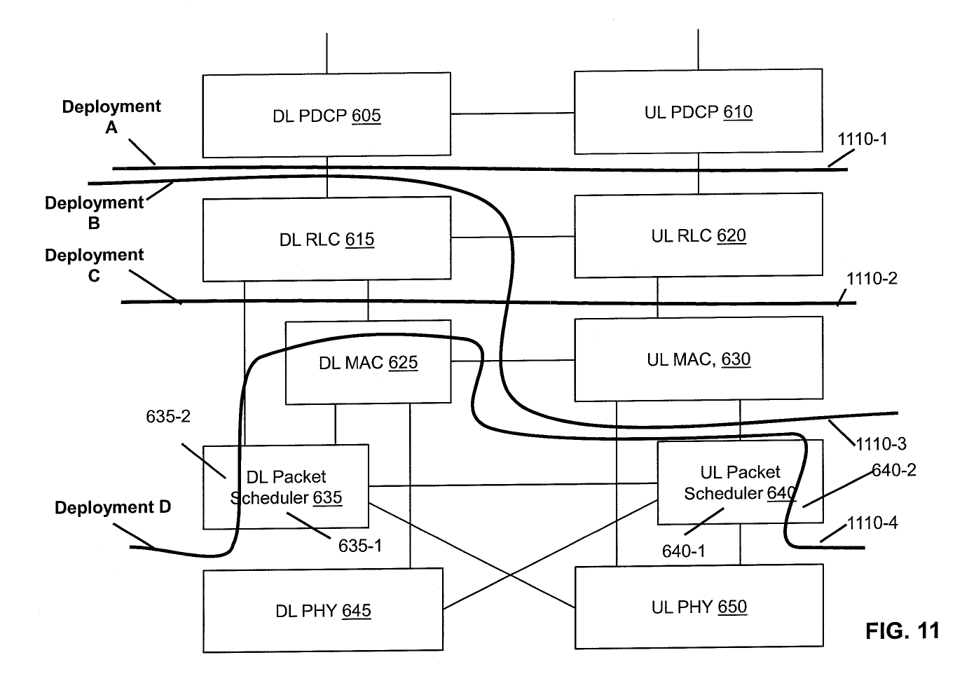

The following four deployments are examples of possible deployments, each having advantages. Reference may be made to FIG. 11, which shows a high level block diagram of layers 1 and 2, illustrating functional elements and exemplary splits between the functional elements for four exemplary deployment scenarios.

Deployment A (indicated by line 1110-1, which corresponds to interface 555):

The access point 130, in the L2 functionality portion 530, contains the following:
The downlink and uplink RLC protocols and their functionality 615, 620 (respectively) and the downlink and uplink MAC protocols and their functionality 625, 630 (respectively); and
The downlink and uplink packet schedulers 635, 640 (respectively).

The access controller 12, in the L2 functionality portion 540, contains the following: the PDCP protocols and their corresponding functionalities 605, 610 (respectively).

Non-limiting advantages to this deployment include but are not limited to the following:
All latency-critical processing is deployed on the access point 130.
The deployment follows 3GPP protocol boundaries.
Air interface ciphering is in the remote node (i.e., access point 130), meaning it is not mandatory to protect the interface between the access points 130 and access controllers 12 with IPsec.

Deployment B (indicated by line 1110-2, which corresponds to interface 555):

The access point 130, in the L2 functionality portion 530, includes the following:
The downlink RLC protocol and its corresponding functionality 615 and the downlink MAC protocol and its corresponding functionality 625; and
The downlink and uplink packet schedulers 635, 640 (respectively) and their corresponding functions.

The access controller 12, in the L2 functionality portion 540, includes the following:
The PDCP protocols and their corresponding functionalities 605, 610; and
The uplink RLC protocol and its corresponding functionality 620 and the uplink MAC protocol and its corresponding functionality 630.

Non-limiting advantages to this deployment include but are not limited to the following:
All latency-critical processing deployed on the access point 130;
Deployed functionality on the access controller 12 is maximized; and
Air interface ciphering is in the remote node (i.e., access point 130), meaning it is not mandatory to protect the interface between the access points 130 and access controllers 12 with IPsec.

Deployment C (indicated by line 1110-3, which corresponds to interface 555):

The access point 130, in the L2 functionality portion 530, includes the following:
The downlink and uplink MAC protocols and their corresponding functionalities 625, 630 (respectively); and
The downlink and uplink packet schedulers 635, 640 (respectively) and their corresponding functions.

The access controller 12, in the L2 functionality portion 540, includes the following:
The PDCP protocols and their corresponding functionalities 605, 610; and
The downlink and uplink RLC protocols and their corresponding functionalities 615, 620.

Non-limiting advantages to this deployment include but are not limited to the following:
The deployment follows 3GPP protocol boundaries; and
Air interface ciphering is in the remote node (i.e., access point 130), meaning it is not mandatory to protect the interface between the access points 130 and access controllers 12 with IPsec.

Deployment D (indicated by line 1110-4, which corresponds to interface 555):

The access point 130, in the L2 functionality portion 530, includes the following:
A lower part of MAC including HARQ and multiplexing and their corresponding functionality 625, 630, and real-time packet schedulers 635-1, 640-1 as part of this lower part.

The access controller 12, in the L2 functionality portion 540, includes the following:
PDCP protocol and its corresponding functionality 605, 610;
Downlink and uplink RLC protocols and their corresponding functionality 615, 620; and
An upper part of MAC including pre-schedulers 635-2, 640-2, which generates scheduling policies for the real-time packet schedulers 635-1, and 640-1 in the access point 130. That is, actual scheduling is carried out by real-time packet schedulers 635-1, 640-1, and scheduling policies are generated by pre-schedulers 635-2, 640-2. The pre-schedulers 635-2 and 640-2 create scheduling policies and communicate the scheduling policies to the real-time packet schedulers 635-1 and 640-1. Meanwhile, the real-time packet schedulers 635-1 and 640-3 in the access point implement the scheduling based on such scheduling policies.

Non-limiting advantages to this deployment include but are not limited to the following:
Pre-schedulers 635-2, 640-2 in the access controller 12 can optimize based on neighboring cell information, a key enabler for CoMP. This higher level of optimization does not need real-time processing but requires instead a larger pool of computing power, thus a good fit for the access controller 12.
Air interface ciphering is in the access controller 12, meaning it is not mandatory to protect the interface between the access points 130 and access controllers 12 with IPsec.

The various functionalities shown in FIG. 11 are typically performed by circuitry including one or more processors (e.g., one or more DPs 130A in an access point 130 or one or more DPs 12A in an access controller 12) that execute computer instructions (e.g., PROGs 130C, 12C). For instance, the L2 layer in an LTE eNB typically will implemented via a combination of DSP (digital signal processor) and CPU (central processing unit). In one particular implementation, MAC, RLC and PDCP are implemented using a Texas Instrument DSP (or a DSP pool). Some vendors implement MAC, RLC and PDCP on generic CPU (typically, multi-core) with a real time operating system (as PROGs 130C, 12C) or a simple executive (as PROGs 130C, 12C). Alternatively or in addition to use of one or more processors, hardware such as integrated circuits may be used.

It is noted that the MAC functionalities 625, 630 include but are not limited to the following functions (see 3GPP TS 36.300, section 6.1 and particularly section 6.1.1):
Mapping between logical channels and transport channels;
Multiplexing/demultiplexing of MAC SDUs belonging to one or different logical channels into/from transport blocks (TB) delivered to/from the physical layer on transport channels;
Scheduling information reporting;
Error correction through HARQ;
Priority handling between logical channels of one UE;
Priority handling between UEs by means of dynamic scheduling;
MBMS service identification;
Transport format selection; and
Padding.

The RLC functionalities 615, 620 include but are not limited to the following functions (see 3GPP TX 36.300, section 6.2 and particularly section 6.2.1):
Transfer of upper layer PDUs;
Error correction through ARQ (only for AM data transfer);
Concatenation, segmentation and reassembly of RLC SDUs (only for UM and AM data transfer);
Re-segmentation of RLC data PDUs (only for AM data transfer);
Reordering of RLC data PDUs (only for UM and AM data transfer);
Duplicate detection (only for UM and AM data transfer);
Protocol error detection (only for AM data transfer);
RLC SDU discard (only for UM and AM data transfer); and
RLC re-establishment.

The PDCP functionalities 605, 610 include but are not limited to the following (see 3GPP TX 36.300, section 6.3 and particularly section 6.3.1):

For the user plane:
Header compression and decompression: ROHC only;
Transfer of user data;
In-sequence delivery of upper layer PDUs at PDCP re-establishment procedure for RLC AM;
Duplicate detection of lower layer SDUs at PDCP re-establishment procedure for RLC AM;
Retransmission of PDCP SDUs at handover for RLC AM;
Ciphering and deciphering; and
Timer-based SDU discard in uplink.

For the control plane:
Ciphering and integrity protection; and
Transfer of control plane data.

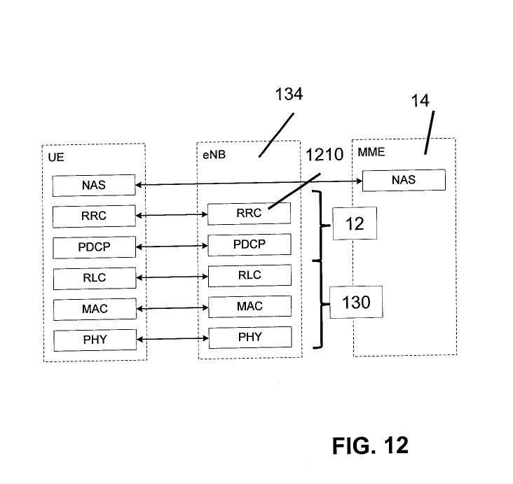

The above examples primarily related to user plane functionality. In addition to user-plane functionality, an eNB 134 and its access controller 12 would also implement control-plane functionality. See FIG. 12. This example uses Deployment A from above. The RRC functionality 1210 is part of the access controller 12. The RRC functionality 1210 include but are not limited to the following functions (see sections 4.3.2 and 7 of 3GPP TS 36.300):
Broadcast;
Paging;
RRC connection management;
RB control;
Mobility functions; and
UE measurement reporting and control.

Exemplary advantages of this invention include one or more of the following non-limiting examples:
Significantly lower backhaul requirements between the access point and access controller: e.g., 150 Mbps versus 3 Gbps.
Ensure stringent latency requirement for LTE baseband processing.
Optimize support for C-RAN and many LTE-Advanced features such as CoMP and SON (self organizing network), due to its hybrid centralized and distributed architecture.
Simplify the centralized management of many LTE access points, such as interference and radio resource management, remote software upgrade and feature releases.

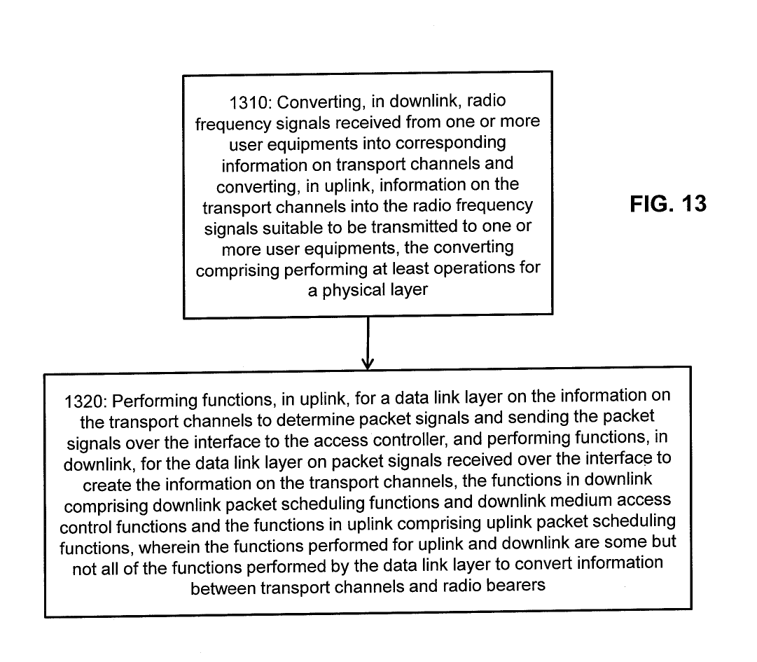

FIG. 13 is a logic flow diagram performed by an access point that illustrates the operation of a method, and a result of execution of computer program instructions embodied on a computer readable medium, in accordance with the exemplary embodiments of this invention. In block 1310, the access point 130 performs converting, in downlink, radio frequency signals received from one or more user equipments into corresponding information on transport channels and converting, in uplink, information on the transport channels into the radio frequency signals suitable to be transmitted to one or more user equipments. The converting includes performing at least operations for a physical layer. In block 1320, the access point 130 performs functions, in uplink, for a data link layer on the information on the transport channels to determine packet signals and sending the packet signals over the interface to the access controller. The access point also performs functions, in downlink, for the data link layer on packet signals received over the interface to create the information on the transport channels. The functions in downlink include downlink packet scheduling functions and downlink medium access control functions and the functions in uplink comprising uplink packet scheduling functions. The functions performed for uplink and downlink are some but not all of the functions performed by the data link layer to convert information between transport channels and radio bearers.

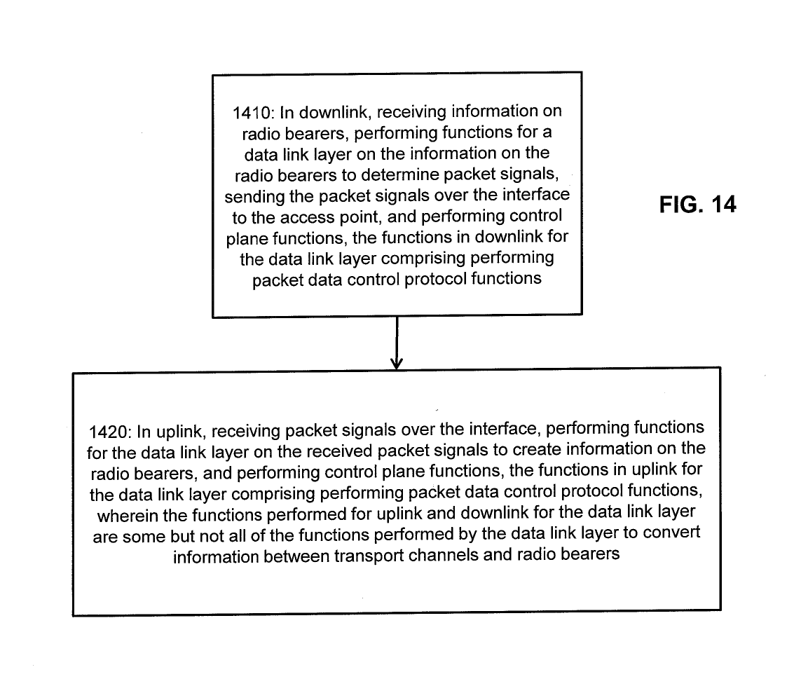

FIG. 14 is a logic flow diagram performed by an access controller that illustrates the operation of a method, and a result of execution of computer program instructions embodied on a computer readable medium, in accordance with the exemplary embodiments of this invention. In block 1410, the access controller 12 performs, in downlink, receiving information on radio bearers, performing functions for a data link layer on the information on the radio bearers to determine packet signals, sending the packet signals over the interface to the access point, and performing control plane functions (e.g., RRC functions as described above). The functions in downlink for the data link layer include performing packet data control protocol functions. In block 1420, the access controller performs, in uplink, receiving packet signals over the interface, performing functions for the data link layer on the received packet signals to create information on the radio bearers, and performing control plane functions (e.g., RRC functions as described above). The functions in uplink for the data link layer include performing packet data control protocol functions. The functions performed for uplink and downlink for the data link layer are some but not all of the functions performed by the data link layer to convert information between transport channels and radio bearers.

In additional exemplary embodiments, an apparatus includes means for converting, in downlink, radio frequency signals received from one or more user equipments into corresponding information on transport channels and converting, in uplink, information on the transport channels into the radio frequency signals suitable to be transmitted to one or more user equipments, the means for converting comprising means for performing at least operations for a physical layer; and means for performing functions, in uplink, for a data link layer on the information on the transport channels to determine packet signals and sending the packet signals over an interface to an access controller, and means for performing functions, in downlink, for the data link layer on packet signals received over the interface to create the information on the transport channels, the means for performing the functions in downlink comprising means for performing downlink packet scheduling functions and means for performing downlink medium access control functions and the means for performing functions in uplink comprising means for performing uplink packet scheduling functions, wherein the functions performed for uplink and downlink are some but not all of the functions performed by the data link layer to convert information between transport channels and radio bearers.

In an additional exemplary embodiment, an apparatus includes, in downlink, means for receiving information on radio bearers, means for performing functions for a data link layer on the information on the radio bearers to determine packet signals, means for sending the packet signals over an interface to an access point, and means for performing control plane functions, the means for performing functions in downlink for the data link layer comprising means for performing packet data control protocol functions; and in downlink, means for receiving packet signals over the interface, means for performing functions for the data link layer on the received packet signals to create information on the radio bearers, and means for performing control plane functions, the means for performing functions in downlink for the data link layer comprising means for performing packet data control protocol functions, wherein the functions performed for uplink and downlink for the data link layer are some but not all of the functions performed by the data link layer to convert information between transport channels and radio bearers.

Embodiments of the present invention may be implemented in software (executed by one or more processors), hardware, or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted, e.g., in FIG. 9. A computer-readable medium may comprise a computer-readable storage medium (e.g., device) that may be any media or means that can contain or store the instructions for use by or in connection with a system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims below.

It is also noted herein that while the above describes example embodiments of the invention, these descriptions should not be viewed in a limiting sense. Rather, there are several variations and modifications which may be made without departing from the scope of the present invention as recited below in the claims.

1. An apparatus, comprising:
an interface coupled to an access controller;
one or more processors; and
one or more memories including computer program code,
the one or more memories and the computer program code configured to, with the one or more processors, cause the apparatus to perform at least the following:
converting, in downlink, radio frequency signals received from one or more user equipments into corresponding information on transport channels and converting, in uplink, information on the transport channels into the radio frequency signals suitable to be transmitted to one or more user equipments, the converting comprising performing at least operations for a physical layer; and
performing functions, in uplink, for a data link layer on the information on the transport channels to determine packet signals and sending the packet signals over the interface to the access controller, and performing functions, in downlink, for the data link layer on packet signals received over the interface to create the information on the transport channels, the functions in downlink comprising downlink packet scheduling functions and downlink medium access control functions and the functions in uplink comprising uplink packet scheduling functions, wherein the functions performed for uplink and downlink are some but not all of the functions performed by the data link layer to convert information between transport channels and radio bearers.

2. The apparatus of claim 1, wherein the downlink packet scheduling functions comprise real-time downlink packet scheduling functions that receive one or more downlink scheduling policies over the interface, and wherein the uplink packet scheduling functions comprise real-time uplink packet scheduling functions that receive one or more uplink scheduling policies over the interface.

3. The apparatus of claim 1, wherein the functions in uplink further comprise medium access control functions.

4. The apparatus of claim 1, wherein the functions in downlink further comprise radio link control functions and pre-scheduler functions and wherein the functions in uplink further comprise pre-scheduler functions.

5. The apparatus of claim 4, wherein the functions in uplink further comprise medium access control functions and radio link control functions.

6. The apparatus of claim 1, wherein the interface comprises one of a wired interface coupled to a copper link coupled to the access controller, a wireless interface providing a wireless link to the access controller, or an optical interface providing an optical link coupled to the access controller.

7. The apparatus of one of claim 6, wherein the interface comprises an Ethernet interface.

8. A method, comprising:
converting, in downlink, radio frequency signals received from one or more user equipments into corresponding information on transport channels and converting, in uplink, information on the transport channels into the radio frequency signals suitable to be transmitted to one or more user equipments, the converting comprising performing at least operations for a physical layer; and
performing functions, in uplink, for a data link layer on the information on the transport channels to determine packet signals and sending the packet signals over an interface to an access controller, and performing functions, in downlink, for the data link layer on packet signals received over the interface to create the information on the transport channels, the functions in downlink comprising downlink packet scheduling functions and downlink medium access control functions and the functions in uplink comprising uplink packet scheduling functions, wherein the functions performed for uplink and downlink are some but not all of the functions performed by the data link layer to convert information between transport channels and radio bearers.

9. The method of claim 8, wherein the downlink packet scheduling functions comprise real-time downlink packet scheduling functions that receive one or more downlink scheduling policies over the interface, and wherein the uplink packet scheduling functions comprise real-time uplink packet scheduling functions that receive one or more uplink scheduling policies over the interface.

10. The method of claim 8, wherein the functions in uplink further comprise medium access control functions.

11. The method of claim 8, wherein the functions in downlink further comprise radio link control functions and pre-scheduler functions and wherein the functions in uplink further comprise pre-scheduler functions.

12. The method of claim 11, wherein the functions in uplink further comprise medium access control functions and radio link control functions.

13. The method of claim 8, wherein the interface comprises one of a wired interface coupled to a copper link coupled to the access controller, a wireless interface providing a wireless link to the access controller, or an optical interface providing an optical link coupled to the access controller.

14. The method of one of claim 13, wherein the interface comprises an Ethernet interface.

15. (canceled)

16. An apparatus, comprising:
an interface coupled to an access point;
one or more processors; and
one or more memories including computer program code,
the one or more memories and the computer program code configured to, with the one or more processors, cause the apparatus to perform at least the following:
in downlink, receiving information on radio bearers, performing functions for a data link layer on the information on the radio bearers to determine packet signals, sending the packet signals over the interface to the access point, and performing control plane functions, the functions in downlink for the data link layer comprising performing packet data control protocol functions; and
in uplink, receiving packet signals over the interface, performing functions for the data link layer on the received packet signals to create information on the radio bearers, and performing control plane functions, the functions in uplink for the data link layer comprising performing packet data control protocol functions,
wherein the functions performed for uplink and downlink for the data link layer are some but not all of the functions performed by the data link layer to convert information between transport channels and radio bearers.

17. The apparatus of claim 16, wherein the functions in uplink for the data link layer further comprise radio link control functions and medium access control functions.

18. The apparatus of claim 16, wherein the functions in downlink for the data link layer further comprise radio link control functions and wherein the functions in uplink for the data link layer further comprise radio link control functions.

19. The apparatus of claim 18, wherein the functions in uplink for the data link layer further comprise medium access control functions and a first pre-scheduler that determines one or more first scheduling policies for a first real-time packet scheduler operating on the access point in the uplink and forwards the one or more first scheduling policies to the real-time packet scheduler via the interface, and wherein the functions in downlink for the data link layer further comprise a second pre-scheduler that determines one or more second scheduling policies for a second real-time packet scheduler function operating on the access point in the downlink and forwards the one or more second scheduling policies to the second real-time packet scheduler via the interface.

20. The apparatus of claim 16, wherein the interface comprises one of a wired interface coupled to a copper link coupled to the access point, a wireless interface providing a wireless link to the access point, or an optical interface coupled to an optical link coupled to the access point.

21. The apparatus of claim 20, wherein the interface comprises an Ethernet interface.

22.-28. (canceled)
